(19) United States
(12) Patent Application Publication
(10) Pub. No.: US 2019/0319360 A1
(43) Pub. Date: Oct. 17, 2019

(54) 5.8 GHz PLANAR ANTENNA, MICROWAVE INDUCTION MODULE AND PREPARING PROCESS THEREOF

(71) Applicant: Huizhou city yuan sheng Technology Co. Ltd., Huizhou (CN)

(72) Inventors: YANQING CAI, HUIZHOU (CN); WEN WANG, HUIZHOU (CN)

(21) Appl. No.: 16/299,080

(22) Filed: Mar. 11, 2019

(30) Foreign Application Priority Data
Apr. 17, 2018 (CN) 201810343100.2

(51) Int. Cl. H01Q 13/08; H01Q 13/20; H01Q 21/00

(52) U.S. Cl. CPC H01Q 13/08; H01Q 21/0087; H01Q 13/206

(57) ABSTRACT

The present invention is a 5.8 GHz planar antenna, including a PCB, wherein the PCB has two layers, one layer is a base material layer, the other layer is a copper foil layer, the copper foil layer and the base material layer are closely adhered, and the size of the base material layer is larger than the size of the copper foil layer; a first microstrip line is disposed on the copper foil layer, and the first microstrip line and the copper foil layer are integrally formed. The present invention further provides a microwave induction module The present invention further provides a process for preparing a microwave induction module. The 5.8 GHz planar antenna and the microwave induction module are optimal in resonant frequency and low in manufacturing cost.

### FIELD OF THE DISCLOSURE

The disclosure relates to the field of antenna devices, and particularly to a 5.8 GHz planar antenna, a microwave induction module and a preparing process thereof.

### BACKGROUND

The existing 5.8 GHz microwave antennas of the same type mainly adopt the boards special for high-frequency antennas. Currently, Rogers and Arlon are more commonly used. However, the boards special for the high-frequency antennas are expensive and have a long delivery period. As a result, the finished products made of such boards are too high in cost and are not conducive to mass promotion.

The microwave antennas of the same type have developed for several stages. 1. Only the ROGERS boards are adopted, and an antenna plate, an oscillating circuit and a transmitting/receiving circuit are all laminated together. Such process has high process requirements on circuit board factories, and the rate of finished products is hard to control. 2. Only the ROGERS board is adopted, the antenna and the transmitting/receiving circuit are manufactured separately. Such process has simple process requirements on the circuit board factories, but for the antenna manufacturers, the process is complicated, and the antenna and the transmitting/receiving antenna need to be connected together by a conductor. 3. On the basis of the second process, the board of the transmitting/receiving circuit is changed to the FR4 board, and the antenna still adopts the ROGERS board. The antenna manufacturers use the conductor to connect the antenna and the transmitting/receiving circuit together. Compared with the first process structure, the third process already has a very large advantage. However, due to the poor uniformity of a dielectric constant of the FR4 board, the resonant frequency of the manufactured antenna is often not optimal.

### SUMMARY

In order to solve the above problem, an objective of the present invention is to provide a 5.8 GHz planar antenna. The 5.8 GHz planar antenna is not only optimal in resonant frequency but also low in cost. The present invention further provides a microwave induction module and a preparing process thereof.

The technical solution of the present invention is as follows.

A 5.8 GHz planar antenna includes a PCB (printed circuit board). The PCB has two layers, one layer is a base material layer and the other layer is a copper foil layer. The copper foil layer and the base material layer are closely adhered, and the size of the base material layer is larger than the size of the copper foil layer. A first microstrip line is disposed on the copper foil layer, and the first microstrip line and the copper foil layer are integrally formed.

In an embodiment, the first microstrip line is located at an edge of the copper foil layer.

In an embodiment, the first microstrip line has a size of 3 mm to 10 mm in length and 0.4 mm to 0.6 mm in width.

In an embodiment, a material of the first microstrip line is copper.

In an embodiment, the copper foil layer has a size of 16.5 mm to 17.5 mm in length and 11.5 mm to 12.5 mm in width.

In an embodiment, the base material layer has a size of 17 mm to 18.5 mm in length and 12 mm to 13.5 mm in width.

In an embodiment, a feed port is disposed in the copper foil layer.

In an embodiment, a material of the PCB is FR4.

A microwave induction module, includes the above 5.8 GHz planar antenna; and a microwave signal bottom plate, wherein one surface thereof is provided with a high frequency module; and the copper foil layer of the 5.8 GHz planar antenna is attached to the other surface of the microwave signal bottom plate, and is connected to the high frequency module.

In an embodiment, the high frequency module is provided with a second microstrip line.

In an embodiment, The microwave induction module further includes a plurality of bonding pads; wherein the plurality of bonding pads are respectively disposed on the copper foil layer and the microwave signal bottom plate, and the plurality of bonding pads on the copper foil layer are in one-to-one correspondence with the plurality of bonding pads on the microwave signal bottom plate.

In an embodiment, the number of the bonding pads on the copper foil layer and the number of the bonding pads on the microwave signal bottom plate are at least three respectively.

In an embodiment, the at least three bonding pads on the copper foil layer are sequentially connected into a polygonal shape; and the at least three bonding pads on the copper foil layers are sequentially connected into a polygonal shape.

A process for preparing a microwave induction module includes the following steps of: step 1, manufacturing a 5.8 GHz planar antenna; step 2, manufacturing a microwave signal bottom plate, wherein one surface of the microwave signal bottom plate is provided with a high frequency module; and step 3, attaching the copper foil layer of the 5.8 GHz planar antenna to one surface of the microwave signal bottom plate back onto the high frequency module, and connecting with the microwave signal bottom plate by a reflow soldering process to manufacture the microwave induction module.

In an embodiment, step 3 includes the following sub-steps: step 31, preparing a plurality of bonding pads on the surface of the copper foil layer; step 32, preparing a plurality of bonding pads on a one surface of the microwave signal bottom plate back onto the high frequency module; a plurality of bonding pads on the copper foil layer being in one-to-one correspondence with the plurality of bonding pads on the microwave signal bottom plate; step 33, after dispensing solder paste on the bonding pads of the copper foil layer or/and the microwave signal bottom plate, correspondingly attaching the copper foil layer to the microwave signal bottom plate; and step 34, manufacturing a microwave induction module by a reflow soldering process.

In an embodiment, The process for preparing a microwave induction module further includes the following step: step 4, changing a length of the second microstrip line of the high frequency module on the microwave signal bottom plate to adjust a resonant frequency of the high frequency module.

In an embodiment, the length of the second microstrip line is changed by cutting or polishing.

In an embodiment, step 1 includes the following sub-steps: step 11, preparing a base material layer; step 12, preparing a copper foil layer and a first microstrip line by an integral molding process; and step 13, attaching the copper foil layer to the base material layer to obtain a PCB.

The beneficial effects by adopting the technical solution are as follows.

1. The 5.8 GHz planar antenna has a simple manufacturing process with only two layers. The manufactured antenna not only has the optimal resonant frequency, but also does not need to use the expensive board special for high frequency antennas. The FR4 material can be used, and the manufacturing cost is very low.

2. The 5.8 GHz planar antenna is provided with a first microstrip line as adjustment. By adjusting the length of a copper foil to compensate for the inconsistency of the FR4 material, the resonant frequency of the antenna can be optimized.

3. Compared with the existing linear antennas, not only is the size of the 5.8 GHz planar antenna reduced, but also the coverage is greatly improved.

4. Not only can the 5.8 GHz planar antenna normally work at 5.8 GHz, but also a range error of 75 MHz is allowed.

5. The high frequency module of the microwave induction module is provided with a second microstrip line as adjustment. The length of the second microstrip line is adjusted in a manner of cutting or polishing to adjust the resonant frequency of the antenna high frequency module.

6. The microwave induction module has simple manufacturing process and low cost. The copper foil layer and the microwave signal bottom plate are respectively provided with a plurality of bonding pads. The microwave induction module formed by fixed connection of the reflow soldering process is stable in structure.

### BRIEF DESCRIPTION OF THE DRAWINGS

The accompanying drawings illustrated here are provided for further understanding of the present application, and form part of the present application. The schematic embodiments and the illustration thereof of the present application are intended for explaining the present application rather than forming inappropriate limitation to the present application. In the drawings:

FIG. 1 is a top view of a 5.8 GHz planar antenna of the present invention.

FIG. 2 is a side view of a 5.8 GHz planar antenna of the present invention.

FIG. 3 is a sectional view of a microwave induction module in the present invention.

FIG. 4 is a schematic structural view of a 5.8 GHz planar antenna and bonding pads in the present invention.

FIG. 5 is a schematic structural view of a microwave signal bottom plate and bonding pads in the present invention.

FIG. 6 is a schematic structural view of a microwave signal bottom plate, a high frequency module, and a second microstrip line in the present invention.

FIG. 7 is a schematic structural view of a polished or cut second microstrip line in the present invention.

FIG. 8 is a flowchart of a process for preparing a microwave induction module in the present invention.

The names of corresponding components or flows represented by the numbers or letters in the drawings: 1 PCB, 2 Base material layer, 3 Copper foil layer, 4 First microstrip line, 5 Feed port, 6 Microwave signal bottom plate, 7 High frequency module, 8 Second microstrip line, 9 Bonding pad.

### DETAILED DESCRIPTION OF PREFERRED EMBODIMENTS

In the following, multiple embodiments of the present invention are disclosed in the drawings. For the sake of clarity, many practical details are explained in the following description. However, it should be understood that these practical details are not intended to limit the invention. That is, in some embodiments of the present invention, these practical details are not necessary. In addition, some of the well-known and conventional structures and components are shown in the drawings in a simplified schematic manner in order to simplify the drawings.

It should be noted that all directional indications such as up, down, left, right, front, rear . . . in the embodiments of the present invention are only intended to explain the relative positional relationship, the moving condition, and the like between the components in a specific posture as shown in the drawings. If the specific posture changes, the directional indications also change accordingly.

In addition, the description of “first”, “second” and the like in the present invention are only used for the purpose of description, and are not intended to refer to the order or sequence specifically, and not intended to limit the present invention. The description is merely intended for distinguishing the components or operations described with the same technical terms, and should not be understood as indicating or implying the relative importance or implicitly indicating the number of indicated technical features. Thus, the features defined by “first” and “second” may include at least one of the features explicitly or implicitly. In addition, the technical solutions between the respective embodiments may be combined with each other, but must be on the basis of implementation by those skilled in the art. When the combination of the technical solutions is contradictory or impossible to implement, it should be considered that the combination of the technical solutions does not exist, and it is also not within the scope of protection required by the present invention.

In order to further understand the content, features and effects of the present invention, the following embodiments are exemplified and described in detail with reference to the accompanying drawings.

### Embodiment 1

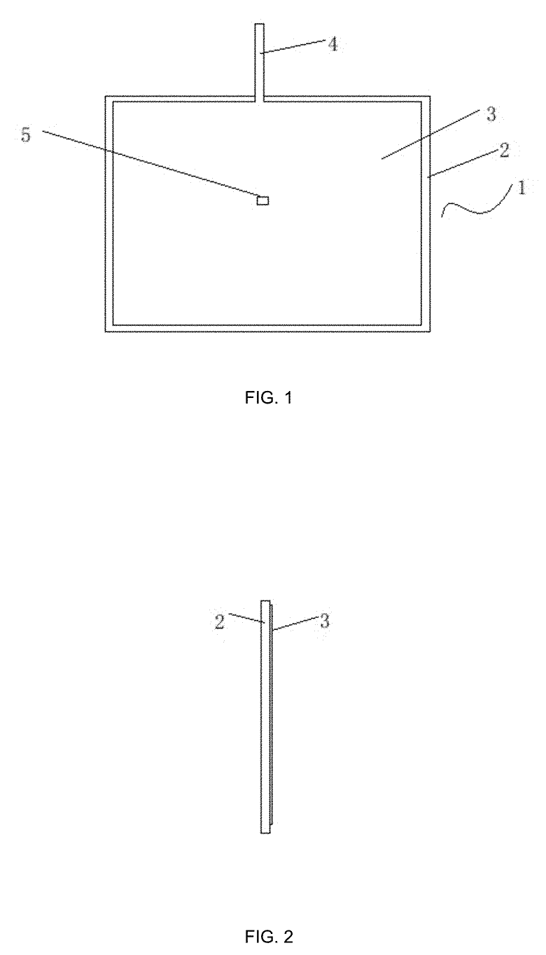

As shown in FIGS. 1 to 2, a 5.8 GHz planar antenna includes a PCB 1. The PCB has two layers, one layer is a base material layer 2, and the other layer is a copper foil layer 3. The copper foil layer 3 and the base material layer 2 are closely attached. The size of the base material layer 2 is larger than the size of the copper foil layer 3. The copper foil layer 3 is provided with a first microstrip line 4, and the first microstrip line 4 and the copper foil layer 3 are integrally formed, and are both made of copper. In this way, such process of integral molding directly simplifies the production procedure process.

Specifically, the first microstrip line 4 is located at the edge of the copper foil layer 3. In the present embodiment, the first microstrip line 4 is located in a middle position of one side of the copper foil layer.

Specifically, the size of the first microstrip line 4 is: 3 mm to 10 mm in length and 0.4 mm to 0.6 mm in width. The present embodiment adopts the length of 3 mm and the width of 0.4 mm.

Specifically, the size of the copper foil layer 3 is: 16.5 mm to 17.5 mm in length and 11.5 mm to 12.5 mm in width. The present embodiment adopts the length of 16.5 mm and the width of 11.5 mm.

Specifically, the size of the base material layer 2 is: 17 mm to 18.5 mm in length and 12 mm to 13.5 mm in width. The present embodiment adopts the length of 17 mm and the width of 12 mm.

Specifically, a feed port 5 is disposed in the copper foil layer 3. There is at least one feed port, configured to connect other instruments and equipment such as a power supply. In the present embodiment, one feed port is disposed.

Specifically, a material of the PCB 1 is FR4. Of course, the material of the PCB 1 may also be selected from other materials. The present embodiment adopts the FR4 material.

### Embodiment 2

The first microstrip line 4 of the horizontal line of the 5.8 GHz planar antenna in the present embodiment has a size of 10 mm in length and 0.6 mm in width. The copper foil layer 3 has a size of 17.5 mm and 12.5 mm in width. The base material layer 2 has a size of 18.5 mm and 13.5 mm in width. The design and connecting manners of other components are the same as those in the first embodiment.

### Embodiment 3

The first microstrip line 4 of the horizontal line of the 5.8 GHz planar antenna in the present embodiment has a size of 5 mm in length and 0.5 mm in width. The copper foil layer 3 has a size of 17 mm in length and 12 mm in width. The base material layer 2 has a size of 18 mm in length and 13 mm in width. The design and connecting manners of other components are the same as those in the first embodiment.

### Embodiment 4

The first microstrip line 4 of the horizontal line of the 5.8 GHz planar antenna in the present embodiment has a size of 6 mm in length and 0.5 mm in width. The copper foil layer 3 has a size of 17 mm in length and 12 mm in width. The base material layer 2 has a size of 17 mm in length and 12 mm in width. The design and connecting manners of other components are the same as those in the first embodiment.

### Embodiment 5

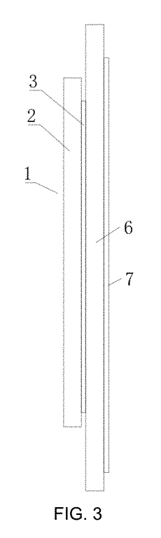

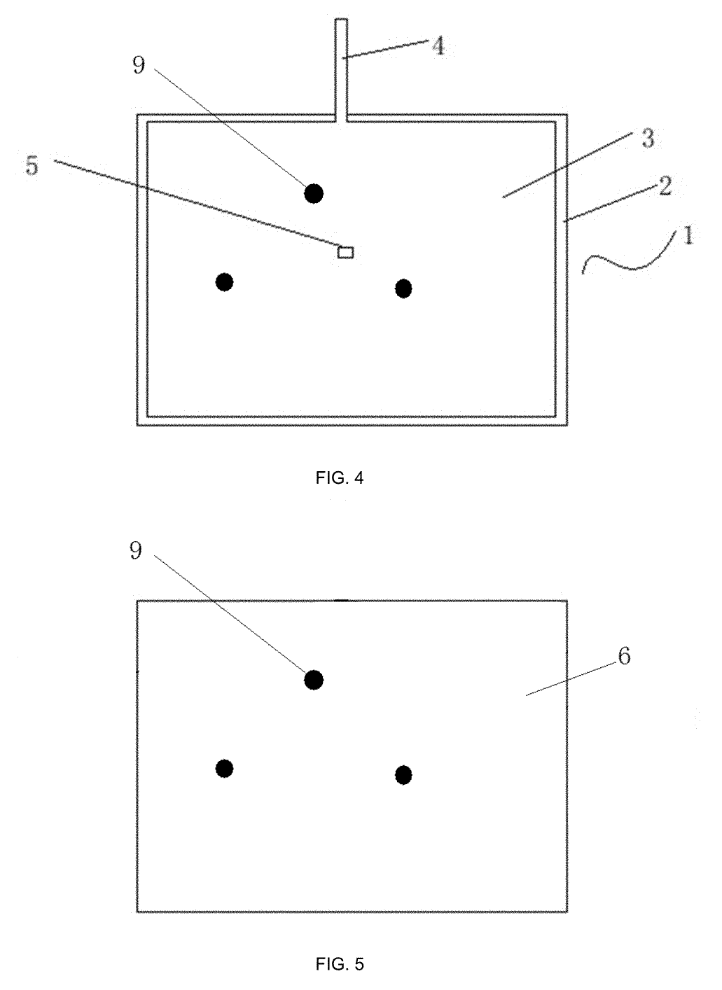

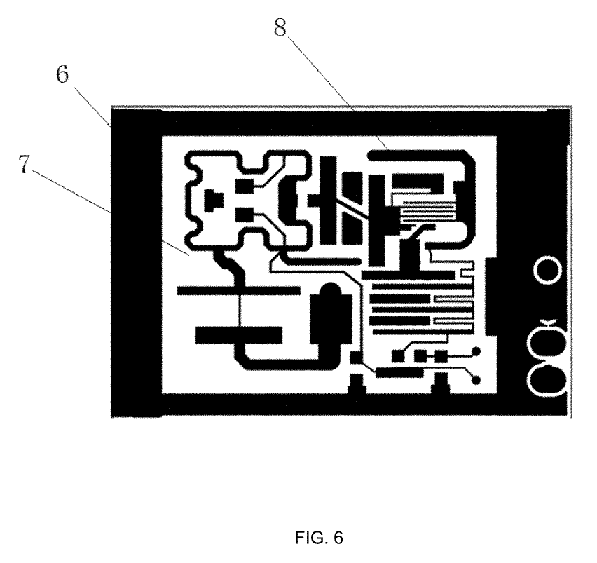

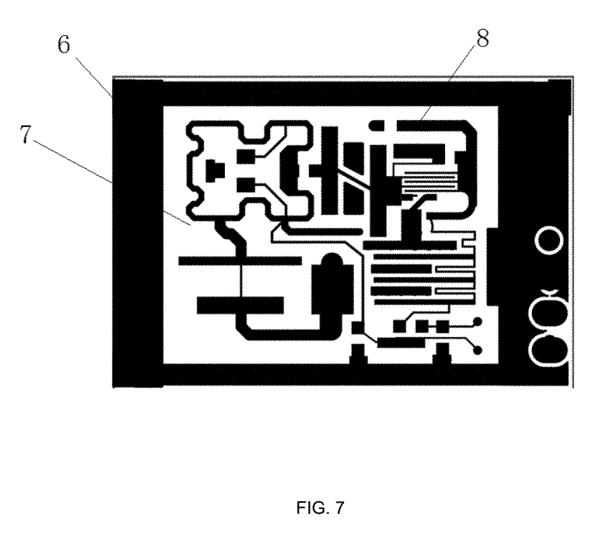

As shown in FIGS. 3 to 6, a microwave induction module includes a 5.8 GHz planar antenna and a microwave signal bottom plate 6. The 5.8 GHz planar antenna is the planar antenna described in any of Embodiments 1 to 4. A high frequency module 7 is disposed on one surface of the microwave signal bottom plate 6, and the copper foil layer 3 of the 5.8 GHz planar antenna is attached to the other surface of the microwave signal bottom plate 6, and is connected to the high frequency module 7. In the present embodiment, the microwave signal bottom plate 6 is a circuit board, and the high frequency module 7 is a high frequency circuit etched on the circuit board.

Specifically, the high frequency module 7 is provided with a second microstrip line 8. The resonant frequency of the high frequency module 7 may be adjusted by changing the length of the second microstrip line 8 through cutting or polishing.

Specifically, the microwave induction module includes a plurality of bonding pads 9. The plurality of bonding pads 9 are respectively disposed on one surface of the copper foil layer 3 back onto the base material layer 2 and one surface of the microwave signal bottom plate 6 back onto the high frequency module 7. The plurality of bonding pads 9 located on the copper foil layer 3 are in one-to-one correspondence with the plurality of bonding pads 9 on the microwave signal bottom plate 6. The 5.8 GHz planar antenna and the microwave signal bottom plate 6 are soldered together through the plurality of bonding pads 9. At this point, the 5.8 GHz planar antenna and the high frequency module 7 form a telecommunication connection relationship.

Specifically, the number of the bonding pads 9 on the copper foil layer 3 and the number of the bonding pads 9 on the microwave signal bottom plate 6 are at least three. The at least three bonding pads 9 on the copper foil layer 3 are sequentially connected into a polygonal shape. The at least three bonding pads 9 on the microwave signal bottom plate 6 are sequentially connected into a polygonal shape, so that the soldering positions of the copper foil layer 3 and the microwave signal bottom plate 6 are evenly distributed, and further the soldering between the two is steady. Preferably, the number of the bonding pads 9 on the copper foil layer 3 and the number of the bonding pads 9 on the microwave signal bottom plate 6 are both three. The three bonding pads 9 on the copper foil layer 3 are sequentially connected into a triangular shape. The three bonding pads 9 on the microwave signal bottom plate 6 are sequentially connected into a triangular shape.

The design and connecting manners of other components are the same as those in the first embodiment.

### Embodiment 6

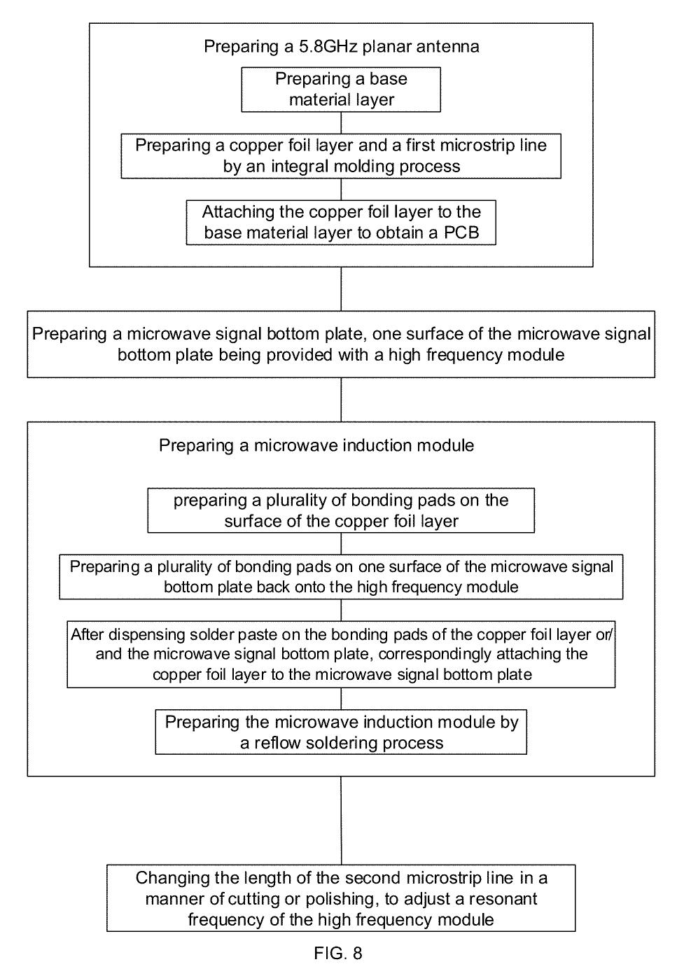

As shown in FIG. 8, a process for preparing a microwave induction module includes the following steps.

Step 1, a 5.8 GHz planar antenna is manufactured. Specifically, the 5.8 GHz planar antenna is prepared by the following sub-steps.

Step 11, a base material layer 2 is prepared, and may be prepared by an FR4 material specifically.

Step 12, a copper foil layer 3 and a first microstrip line 4 are prepared by adopting an integral molding process. Specifically, the copper foil layer 3 and the first microstrip line 4 are made of copper, and may be manufactured by a rolled copper foil.

Step 13, the copper foil layer 3 is attached to the base material layer 2 to manufacture the PCB 1.

Step 2, a microwave signal bottom plate 6 is prepared, and one surface of the microwave signal bottom plate 6 is provided with a high frequency module 7. In the present embodiment, the microwave signal bottom plate 6 is a circuit board, and the high frequency module 7 is a high frequency circuit etched on the circuit board.

Step 3, the copper foil layer 3 of the 5.8 GHz planar antenna is attached to one surface of the microwave signal bottom plate 6 back onto the high frequency module 7, and is steadily connected to the microwave signal bottom plate 6 by a reflow process, so as to manufacture the microwave induction module. Specifically, the following sub-steps are included.

Step 31, a plurality of bonding pads 9 are prepared on the surface of the copper foil layer 3. The plurality of bonding pads 9 may be formed on the copper foil layer 3 by an etching process. In the present embodiment, the number of the bonding pads 6 on the copper foil layer 3 is three, and the three bonding pads 6 are sequentially connected into a triangular shape.

Step 32, a plurality of bonding pads 9 are prepared on one surface of the microwave signal bottom plate 6 back onto the high frequency module 7. The plurality of bonding pads 9 may be prepared on the microwave signal bottom plate 6 by an etching process. The plurality of bonding pads 9 on the copper foil layer 3 are in one-to-one correspondence with the plurality of bonding pads 9 on the microwave signal bottom plate 6.

After solder paste is dispensed on the bonding pads 9 of the copper foil layer 3 or/and the microwave signal bottom plate 6, the copper foil layer 3 is correspondingly attached to the microwave signal bottom plate 6. Specifically, there are three ways to dispense the solder paste. The first way is to dispense the solder paste on the bonding pads 9 of the copper foil layer 3 separately. The second way is to dispense the solder paste on the bonding pads 9 of the microwave signal bottom plate 6. The third way is to dispense the solder paste on both the copper foil layer 3 and the microwave signal bottom plate 6.

The microwave induction module is manufactured by a reflow soldering process. Specifically, the reflow soldering process may be performed by a desktop reflow oven or a vertical reflow oven. After passing by the desktop reflow oven or the vertical reflow oven, the bonding pads 9 of the 5.8 GHz planar antenna and the bonding pads 9 of the microwave signal bottom plate 6 are soldered together to form a steady connecting relationship. At this point, the 5.8 GHz planar antenna and the high frequency module 7 form a telecommunication connection relationship.

In step 4, the length of the second microstrip line 8 is changed by a manner of cutting or polishing, so as to adjust the resonant frequency of the high frequency module 7, so that the resonant frequency of the high frequency module 7 is accurate to 5.8 GHz+−75 MHz.

The above discussion and illustration are some of the application cases of our invention. It aims to help to understand the principle and techniques in our invention. Any other form of different combination, alter or change would be covered by this patent. Any improvement that based at our invention should be covered in this patent.

What is claimed is:

1. A 5.8 GHz planar antenna, comprising a PCB, the PCB having two layers, one layer being a base material layer and the other layer being a copper foil layer, wherein the copper foil layer and the base material layer are closely adhered, and the size of the base material layer is larger than the size of the copper foil layer; and a first microstrip line is disposed on the copper foil layer, and the first microstrip line and the copper foil layer are integrally formed.

2. The 5.8 GHz planar antenna according to claim 1, wherein the first microstrip line is located at an edge of the copper foil layer.

3. The 5.8 GHz planar antenna according to claim 2, wherein the first microstrip line has a size of 3 mm to 10 mm in length and 0.4 mm to 0.6 mm in width.

4. The 5.8 GHz planar antenna according to claim 1, wherein a material of the first microstrip line is copper.

5. The 5.8 GHz planar antenna according to claim 1, wherein the copper foil layer has a size of 16.5 mm to 17.5 mm in length and 11.5 mm to 12.5 mm in width.

6. The 5.8 GHz planar antenna according to claim 1, wherein the base material layer has a size of 17 mm to 18.5 mm in length and 12 mm to 13.5 mm in width.

7. The 5.8 GHz planar antenna according to claim 1, wherein a feed port is disposed in the copper foil layer.

8. The 5.8 GHz planar antenna according to claim 1, wherein a material of the PCB is FR4.

9. A microwave induction module, comprising:
the 5.8 GHz planar antenna according to claim 1; and
a microwave signal bottom plate, wherein one surface thereof is provided with a high frequency module; and the copper foil layer of the 5.8 GHz planar antenna is attached to the other surface of the microwave signal bottom plate, and is connected to the high frequency module.

10. The microwave induction module according to claim 9, wherein the high frequency module is provided with a second microstrip line.

11. The microwave induction module according to claim 9, further comprising a plurality of bonding pads; wherein the plurality of bonding pads are respectively disposed on the copper foil layer and the microwave signal bottom plate, and the plurality of bonding pads on the copper foil layer are in one-to-one correspondence with the plurality of bonding pads on the microwave signal bottom plate.

12. The microwave induction module according to claim 11, wherein the number of the bonding pads on the copper foil layer and the number of the bonding pads on the microwave signal bottom plate are at least three respectively.

13. The microwave induction module according to claim 12, wherein the at least three bonding pads on the copper foil layer are sequentially connected into a polygonal shape;
and the at least three bonding pads on the copper foil layers are sequentially connected into a polygonal shape.

14. A process for preparing a microwave induction module, comprising the following steps of:
step 1, manufacturing a 5.8 GHz planar antenna;
step 2, manufacturing a microwave signal bottom plate, wherein one surface of the microwave signal bottom plate is provided with a high frequency module; and
step 3, attaching the copper foil layer of the 5.8 GHz planar antenna to one surface of the microwave signal bottom plate back onto the high frequency module, and connecting with the microwave signal bottom plate by a reflow soldering process to manufacture the microwave induction module.

15. The process for preparing a microwave induction module according to claim 14, wherein step 3 comprises the following sub-steps:
step 31, preparing a plurality of bonding pads on the surface of the copper foil layer;
step 32, preparing a plurality of bonding pads on a one surface of the microwave signal bottom plate back onto the high frequency module; a plurality of bonding pads on the copper foil layer being in one-to-one correspondence with the plurality of bonding pads on the microwave signal bottom plate;
step 33, after dispensing solder paste on the bonding pads of the copper foil layer or/and the microwave signal bottom plate, correspondingly attaching the copper foil layer to the microwave signal bottom plate; and
step 34, manufacturing a microwave induction module by a reflow soldering process.

16. The process for preparing a microwave induction module according to claim 15, further comprising the following step:
step 4, changing a length of the second microstrip line of the high frequency module on the microwave signal bottom plate to adjust a resonant frequency of the high frequency module.

17. The process for preparing a microwave induction module according to claim 16, wherein the length of the second microstrip line is changed by cutting or polishing.

18. The process for preparing a microwave induction module according to claim 14, wherein step 1 comprises the following sub-steps:
step 11, preparing a base material layer;
step 12, preparing a copper foil layer and a first microstrip line by an integral molding process; and
step 13, attaching the copper foil layer to the base material layer to obtain a PCB.
